(19) United States
(12) Patent Application Publication
(10) Pub. No.: US 2007/0289315 A1
(43) Pub. Date: Dec. 20, 2007

(54) Solid state cooling or power generating device and method of fabricating the same

(75) Inventor: Magnus Larsson, Lund (SE)

Correspondence Address: FOLEY AND LARDNER LLP;SUITE 500, 3000 K STREET NW, WASHINGTON, DC, 20007, US

(73) Assignee: Nanofreeze Technologies Lund AB

(21) Appl. No.: 11/797,207

(22) Filed: May 1, 2007

Related U.S. Application Data
(60) Provisional application No. 60/796,531, filed on May 2, 2006.

(51) Int. Cl. F25B 21/02; H01S 4/00

(52) U.S. Cl. 62/3.3; 29/592.1; 977/813

(57) ABSTRACT

The present invention relates to a solid state cooling/power generating device is provided comprising a first and second electrode separated by a vacuum gap. According to the present invention at least one of the electrodes is provided with a nanoscaled heterostructure 301, which comprises at least one quantum well which in combination with the vacuum gap 315 forms a double barrier resonance structure providing conditions which allows resonant tunneling between the first and second electrode.

The present application claims benefit of U.S. Provisional Patent Application Ser. No. 60/796,531, filed May 2, 2006, which is incorporated by reference in its entirety.

### FIELD OF THE INVENTION

The present invention relates to a solid state cooling and/or power generating device. In particular the invention relates to a heatpump comprising nanoscaled semiconductor heterostructures.

### BACKGROUND OF THE INVENTION

The interest in solid state cooling devices has over the last decades shown a significant increase. A solid state cooling device is driven directly by electrical current and the simultaneous cooling and heating of different parts of the device is due to thermoelectrical effects. The solid state cooling devices are typically less effective than conventional refrigerators, but have the advantage of not relying on any moving mechanical parts or needing potentially harmful heat transfer fluids. These features, and the fact that a solid state cooling device can be made much smaller than conventional refrigerating devices, makes the solid state cooling devices well suited for cooling electronic devices and even single microchips. The physical properties giving rise to the cooling/heating effects of a solid state cooling device can also be used to generate a current.

The today only solid state cooling device that is commercially available in significant volumes is cooling devices based on the Peltier element. The Peltier element was introduced and developed in the late 40's and early 50's, and basically only operates on the good thermoelectric properties of the then newly discovered semi-conductor materials. In principle, materials with high electrical conductivity and low thermal conductivity were sought and doped semiconductors such as Bi₂Te₃ found to have suitable properties. A comprehensive description of Peltier elements and their properties is to be found in “Semiconductor Thermoelements and Thermoelectric Cooling”, Ioffe, A. F., 1957, Infosearch, London. As the experience and technical techniques improved, better Peltier elements were introduced. Today, cooling devices based on Peltier elements are found primarily in mobile small size coolers for use in vehicles and as cooling elements in electronic devices and sensors.

An alternative principle for a solid state cooling technique uses two electrodes separated by vacuum and is known as a thermotunneling heatpump (TH). Also this principle has been known for a long time and heatpumps has been suggested and published in scientific journals since the 1930's. The limiting factors of a TH is the width of the vacuum layer, and the magnitude of the electrode material work functions. The heatpump can work either as an active cooling/heating element by supplying electricity, or as a power generator, where an existing temperature difference generates an electric current. The two processes are each others inverse. The term “solid state cooling/power generating device” will be used hereinafter and should be interpreted as encompassing devices used for, and possibly also optimized for cooling/heating and/or power generation.

For cooling, when applying a bias on the device, electrons will tunnel through the potential barrier created by the vacuum gap if it is narrow enough. Since electrons carry heat, one electrode will heat up while the other will cool down. The efficiency of such a device is defined by the heat extracted from the electrode that is to be cooled divided by the power input. The magnitude of the work function needs to be as small as possible, and Ag—O—Cs electrodes have the lowest measured work functions at room temperature of about 1 eV. This restricts the maximum width of the vacuum gap to around 15 Å for efficient operation, which is practically impossible to realize. The same conclusion is valid for a power generator. Due to these constrains the vacuum gap devices have not been able to compete with the well known Peltier elements, and no commercial products exist on the market today.

During the 1990's scientists looked back at the vacuum gap TH, and suggested replacing the vacuum gap by a semiconductor thin film system. Lower work functions could be achieved and calculations showed extremely high efficiency. A few years later it was found that phonon heat conduction (which was blocked by the vacuum gap) played a very destructive role, basically rendering the efficiency of these devices on par (or worse) with the Peltier element. Research is still being performed in this field today trying to find new heterostructures that enhances electron transport while blocking phonons. However, to the extent of the knowledge of the inventor no working prototype or commercial product exists.

Lately the interest in vacuum gap THs has again increased, due to a series of articles describing experiments showing the great potential of vacuum gap TH, if just the vacuum gap could be constructed thin enough, see for example “Refrigeration By Combined Tunneling and Thermionic Emission in Vacuum: Use of Nanometer Scale Design”, Y. Hishinuma et al., Applied Physics Letters vol 78 (17), April 2001. In the experiments chips of the size of 1 μm×1 μm were used, whereas a size of 1 cm×1 cm is necessary for a commercial product. It is, with today known manufacturing methods, exceedingly difficult to produce chips with such large area and a vacuum gap in the order of 10-20 Å.

In WO 2004/049379 a tunnelling vacuum cooling device is disclosed wherein one or both of the electrodes are covered with a thin (5-50 Å) insulator layer, for example aluminium oxide. The arrangement blocks tunneling of low energy electrons (lower than the Fermi energy) which otherwise diminishes the efficiency of a TH without any insulator layer, by altering the shape of the electrical field between the electrodes.

In “Vacuum Thermionic Refrigeration with a Semiconductor Heterojunction Structure”, Y. Hishinuma et al., Applied Physics Letters vol. 81 (22), November 2002. a similar filtering of hot electrons is suggested by applying a semiconductor to a metal electrode of the vacuum cooling device. The vacuum barrier is reduced by a combination of a strong applied electrical field and a layered semiconductor heterostructure or a semiconductor with a graded composition. The purpose of the layered heterostructure or composition gradient is to form a Schottky barrier at the metal-semiconductor interface and to reduce joule heating in the semiconductor. A high cooling power is reported; however, the efficiency of the device is still low, due to the large applied electric field.

The prior art publications clearly demonstrates the potential of solid state cooling/power generating devices based on vacuum gaps. However, improved efficiency and designs suited for large scale productions are needed in order for the vacuum gap technology to be an alternative to the Peltier technology commercially.

### SUMMARY OF THE INVENTION

Obviously the prior art vacuum gap heatpumps and cooling devices comprising such needs significant improvements in order to be commercially attractive in comparison with Peltier elements.

A solid state cooling/power generating device is provided comprising a first and second electrode separated by a vacuum gap. According to the present invention at least one of the electrodes is provided with a nanoscaled semiconductor heterostructure, which comprises at least one quantum well which in combination with the vacuum gap forms a double barrier resonance structure providing conditions which allows resonant tunnelling between the first and second electrode.

Preferably the nanoscaled semiconductor heterostructure is arranged to provide resonant tunnelling at a plurality of separate energy windows or transport channels. The energy window with the lowest energy should to its greater part be above a characteristic energy of the electrodes, the Fermi energy plus Boltzmann constant times the temperature (E_{F}+k_{B}T). Even more preferably the energy window with the lowest energy should be arranged to match the characteristic energy as closely as possible.

According to one embodiment of the present invention the nanoscaled semiconductor heterostructure comprises at least a first thin film in connection with a second thin film, and the second thin film adjacent to the vacuum gap. The material of the first thin film should have a wider bandgap than the material of the adjacent second thin film.

The nanoscaled semiconductor heterostructure may according to one embodiment comprises a plurality of first thin films each followed by second thin films in a superlattice arrangement, the superlattice ending with a second thin film adjacent to the vacuum gap.

The first thin film or films may be made of AlN and the second thin film or films of AlGaN.

A method according to the invention of producing a solid state cooling/power generating device comprises the steps of:
growing a metal layer which is to act as the contact to an external electric circuit, on top of a substrate;
providing the nanoscaled semiconductor heterostructure on top of the metal layer by growing one layer of a doped semiconductor, followed by at least one layer of a first material forming a potential barrier, and a layer of a second material, wherein the first material has a wider bandgap than the second material.

In one embodiment the method is complemented with:
providing a mask with through holes on the layer of second material to be adjacent to the vacuum gap;
filling the through holes by growing an insulator on top of the mask;
removing the mask to uncover the insulating spacers;
pressing a second electrode on top of the insulating spacers, the insulating spacers thereby defining the width of the gap formed in between the first and second electrode.

The solid state cooling/power generating device based on vacuum gap according to the invention has very high efficiency and which is possible to manufacture at reasonable costs.

One advantage of the solid state cooling/power generating device according to the invention is that it can be made small and therefore is well suited for cooling electronic device. It can even be integrated in computer chips. The device comprises no moving parts, which is a prerequisite for the reduction of sizes, and also ensures a robustness and reliability.

A further advantage as compared to Peltier elements, is the efficiency. The vacuum gap device according to the invention can be up to 10-15 times more efficient than conventional Peltier elements.

Embodiments of the invention are defined in the dependent claims. Other objects, advantages and novel features of the invention will become apparent from the following detailed description of the invention when considered in conjunction with the accompanying drawings and claims.

### BRIEF DESCRIPTION OF THE DRAWINGS

Preferred embodiments of the invention will now be described with reference to the accompanying drawings, wherein:

FIG. 1a illustrates schematically a quantum well which is a building block in the solid state cooling/power generating device according to the present invention, and 1b is a graph of the corresponding potential profile;

FIG. 2a illustrates schematically a double potential barrier, and 2b is a graph of the corresponding potential profile;

FIG. 3a illustrates schematically the electrode arrangement with a nanoscaled semiconductor heterostructure of the solid state cooling/power generating device according to the present invention, and 3b is a graph of the corresponding potential profile;

FIG. 4a illustrates schematically the electrode arrangement with a nanoscaled semiconductor heterostructure in the form of a superlattice according to one embodiment of the present invention, and 4b is a graph of the corresponding potential profile; and

FIGS. 5a-d illustrate a method of producing the solid state cooling/power generating device according to the present invention, and 5e illustrates schematically the device in an operating scenario.

### DETAILED DESCRIPTION

Thermotunnelling vacuum gap heatpumps have, as discussed in the background section, the potential of delivering very high efficiency as compared to Peltier elements in for example cooling devices. However, the promising theoretical calculations and simulations have shown to be extremely difficult to realize with existing manufacturing methods. The main problem with the prior art suggested vacuum gap heatpumps is the requirement of a vacuum gap in the order of 1-50 Å and with an area of around 1 cm² to be able to provide commercially interesting products. Providing such large electrodes with a gap of that order is with today known methods, at least with an acceptable yield, impossible. Surface roughness, impurities, etc. will unavoidable lead to large variations in the width of the gap, and probably contact between the electrodes in some points, seriously impairing the function of the heatpump.

According to the present invention, a nanoscaled semiconductor heterostructure is provided on at least one of the electrodes of the heatpump and in proximity to the vacuum gap. For the purpose of this application nanoscale refers to at least one part of the heterostructure having dimensions in the nanoregion (1-100 nm) in the direction perpendicular to the plane of the electrode. The term heterostructure refers to the structure having at least two distinguishable parts of different material or composition, wherein at least one of the parts is a semiconductor.

According to the invention, the nanoscaled semiconductor heterostructure is so arranged to provide at least one potential barrier giving, in combination with the vacuum gap, the possibility of quantum mechanical resonant tunneling, hereinafter referred to as resonant tunneling, between the electrodes. Through the resonant tunneling, very high tunneling probability can be achieved for specific electron energies, and the resonant tunneling can be described to create energy windows or transport channels where tunneling probability is very high, in theory even 100%. The device will be referred to as a resonant thermotunneling heatpump (RTH).

The efficiency of a HT is highly dependent on the energy of the electrons, and a for the HT characteristic energy, dependent on material parameters, can be found for which optimum efficiency of the HT can be achieved. The HT characteristic energy relates to the Fermi energy of the electrodes of the HT. Optimal efficiency is achieved for electrons with energies around E_{F}+k_{B}T, (Fermi energy plus Boltzmann constant times the temperature).

According to one embodiment of the RTH of invention the resonant tunneling energy windows, provided by the nanoscale semiconductor heterostructure, is arranged to match the HT characteristic energy. Preferably the resonant tunneling energy window with the lowest energy is to its greater part at, or above, E_{F}+k_{B}T of the HT, defined as the characteristic energy of the electrodes. Even more preferably the resonant tunneling energy window with the lowest energy should be within E_{F}+k_{B}T±(30% of k_{B}T). With this arrangement very high efficiencies can be achieved for a cooling device utilizing such thermotunneling heatpump, even for devices with vacuum gaps significantly wider than required for the above described prior art devices. Using this arrangement vacuum gaps with a width up to 40 Å are expected to give efficiency 10-15 times higher than a Peltier element. Even widths up to 100 Å gives a significant increase.

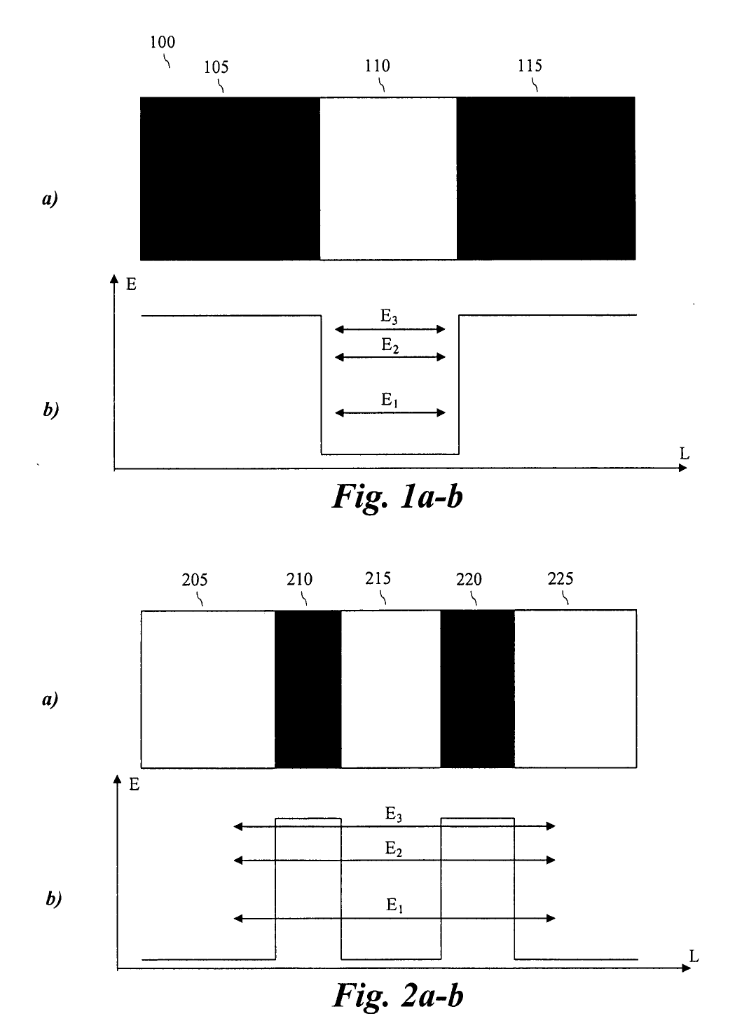

The basic “building block” in providing resonant tunneling is a quantum well. Quantum wells are formed in semiconductors by having a material sandwiched between two layers of a material with a wider bandgap. An arrangement resulting in one quantum well is schematically illustrated in FIG. 1a. The semiconductor nanostructure 100 comprises of a thin film 105 of a first material, a second thin film 110 of a second material and a third thin film 115 of a third material. A convenient arrangement uses the same material, preferably a semiconductor material, in the first 105 and the third 115 thin film. The second thin film 110 is a semiconductor with a narrower band-gap than the other materials in the quantum well. A large number of materials and combination of semiconductors are known, which can be manufactured with required dimensions and with properties giving the required quantum mechanical effects, for example AlN/AlGaN/AlN, AlGaAs/GaAs/AlGaAs and Si/SiGe/Si. The potential profile of the quantum well is displayed in FIG 1b. According to basic quantum mechanics, bound electron states, in the figure exemplified with levels E₁, E₂ and E₃, are present in the well. The width and height of the quantum well determine at which energies these states are, and how large the difference between two states are.

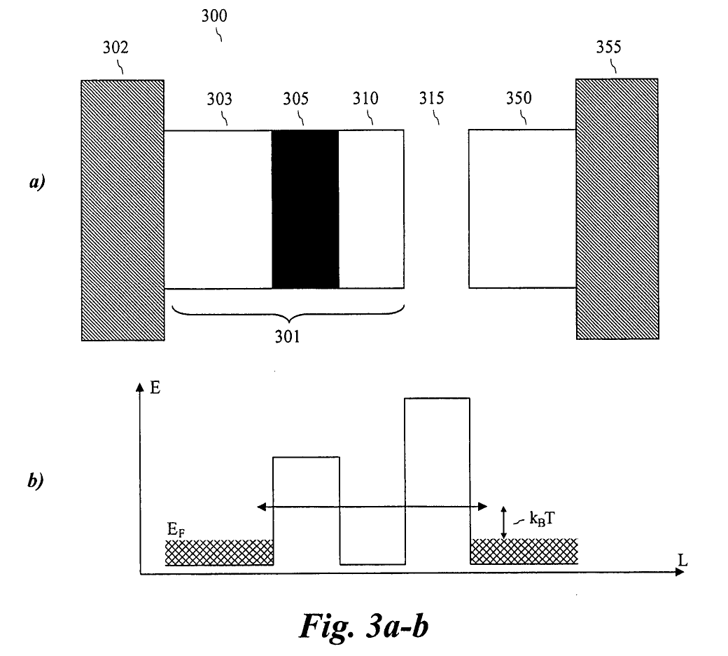

A preferred arrangement according to the present invention creating possibilities for resonant tunneling, comprises at least a double potential barrier. A double barrier resonant tunneling device constructed from 5 layers of different materials is schematically illustrated in FIG. 2a, and it's corresponding potential profile is illustrated in FIG. 2b. The first 205, third 215 and fifth 225 thin films are typically and preferably of the same first semiconductor. The intermediate thin films, the second thin film 210 and the fourth thin film 220 are typically of the same second semiconductor and forms two potential barriers. The tunneling transmission probability across the two potential barriers is usually very low, except for specific electron energies, where the width of the quantum well corresponds to half integers or integers times the electron wavelength, l. The electron energy E depends on the wavelength as E˜(1/l)². At these resonant energies, exemplary illustrated with arrows E₁, E₂ and E₃, the tunneling probability of the electron is 100%, due to wave interference. It is said that the electron is in resonance with the device structure. These resonant energy transport channels have roughly the same energy as the bound states in a quantum well with the same thickness, and with the same potential depth as the potential well in the double barrier structure. By varying structure parameters such as potential barrier height and well widths, the resonant transport channels can be tuned to be located at a specific energy. For the RTH, the energy of the lowest transport channel would ideally be around E_{F}+k_{B}T.

To construct such a double barrier device, the total width of the two layers making up the potential barriers plus the width of the middle layer, corresponding to the well, has to be less than the electron mean free path, for electrons to be able to tunnel without suffering scattering with impurities. The mean free path in doped semiconductors is at least 100 nm at room temperature, for comparison.

If the two potential barriers are not identical, (i.e. different widths, or completely different materials, creating different potential barriers), tunneling probability will be slightly reduced. Furthermore, the energy window will broaden slightly.

In a device where the barriers are solids, the thermal backflow due to phonons will yield a low efficiency, if such a device were to be operated as a RTH. By replacing one of the potential barriers with a vacuum gap, forming the RTH according to the invention, phonon thermal backflow is blocked, and a huge boost in efficiency is expected. By introducing resonant tunneling, the number of electrons participating in the heat transfer will be greatly increased, thereby increasing the overall efficiency of the device. Furthermore a wider vacuum gap (up to 40-50 Å) can be used, making the device easier to construct than a regular TH.

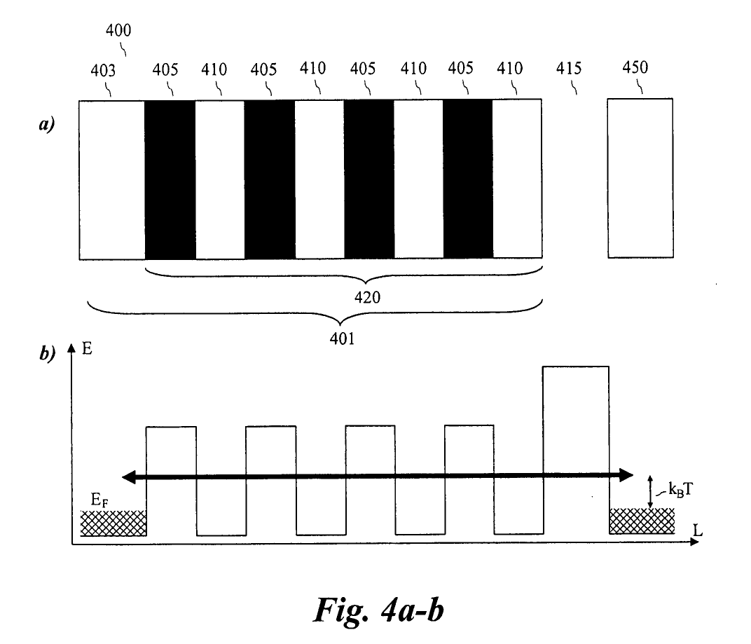

The electrodes comprises of a base that can be made of either metals or doped semiconductors. Since there is no hard restraint on the magnitude of the work function as in a prior art TH, the choice of electrode base materials is less important. FIG. 3a illustrates schematically the structure of a cooling device utilizing a RTH according to the invention, and FIG. 3b the corresponding potential profile. The RTH cooling device 300 comprises a cold reservoir 302 in connection with a first electrode 301 and a second electrode 350 in connection with a hot reservoir 355. The first electrode 301 comprises of the base 303, a first thin film 305 and a second thin film 310. The second thin film 310 is adjacent to the vacuum gap 315. The first thin film 305 and the vacuum gap 315 forms the two potential barriers in similarity with the double barrier structure described with reference to FIG. 2a. The material of the first thin film 305 should have a wider bandgap than the material of the adjacent second thin film 310. Possible material choices for thin films 305 and 310 are insulators or semiconductors. Since the electron transmission window is highly dependant on material properties of the two thin films, their material choice is very important. For example, materials with low electron affinity and workfunctions (such as AlN and doped AlGaN) is preferred since that means the potential barriers will be lower, and hence increase tunneling across the device, increasing performance. Combinations of materials include, but is not limited to for example AlN/AlGaN, AlGaAs/GaAs and Si/SiGe. The width of the two thin films also play a crucial role in the design of the device. The width of the first thin film (305) should not be too thick, since a thicker layer reduces tunneling probability (preferably less than 10 nm). The width of the second thin film (310) determines where the energy transmission window is located and should be chosen so that the lowest transmission channel is close to E_{F}+k_{B}T for optimal performance. The wider the second thin film is, the lower (in energy) will the transmission channels be. The order of magnitude of the widths of the thin films are 1-10 nm depending on material choice as described above.

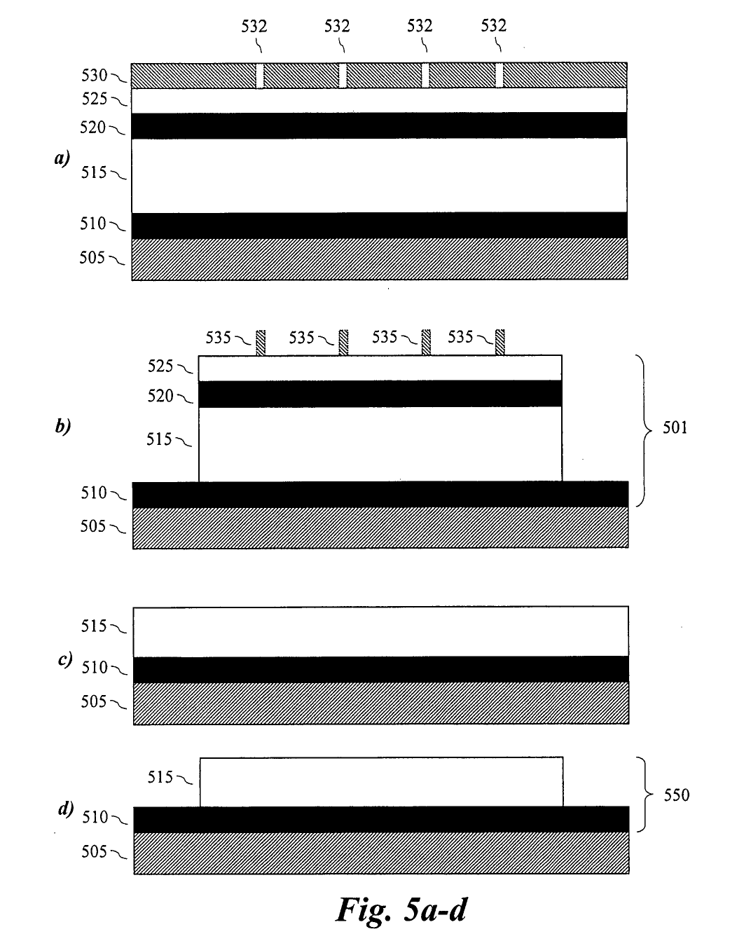

Adding more potential barriers to a resonant tunneling device has the effect of broadening the energy transport channel, which is beneficial, since for a double barrier structure this energy channel is very narrow. A semiconductor superlattice consists of several potential barriers, and has a very wide energy window, called a ‘mini-band’. Such a superlattice could replace the two thin films in FIG. 3 for an even broader transport channel. An RTH comprising a semiconductor superlattice represent a second embodiment of the invention and is schematically illustrated in FIG. 4. A semiconductor superlattice 420 comprising a plurality of semiconductor or insulator thin films having a wider band gap acting as potential barriers 405 alternating with semiconductor thin films 410 having a narrower band gap, is provided on the first electrode base 403, and forms the first electrode 401. The superlattice 401 is adjacent to the vacuum gap 415, being the last potential barrier, followed by the second electrode 450. Optionally, a second nanoscaled semiconductor heterostructure comprising at least one potential barrier thin film and one conductive thin film is provided on the second electrode 450. Alternatively a superlattice structure according to the above is provided on the second electrode 450.

In a further embodiment of the invention several RTH's are stacked on top of each other, each device pumping a smaller amount of heat. The total heat pumped will be equal to a non-stacked system, but the efficiency is increased.

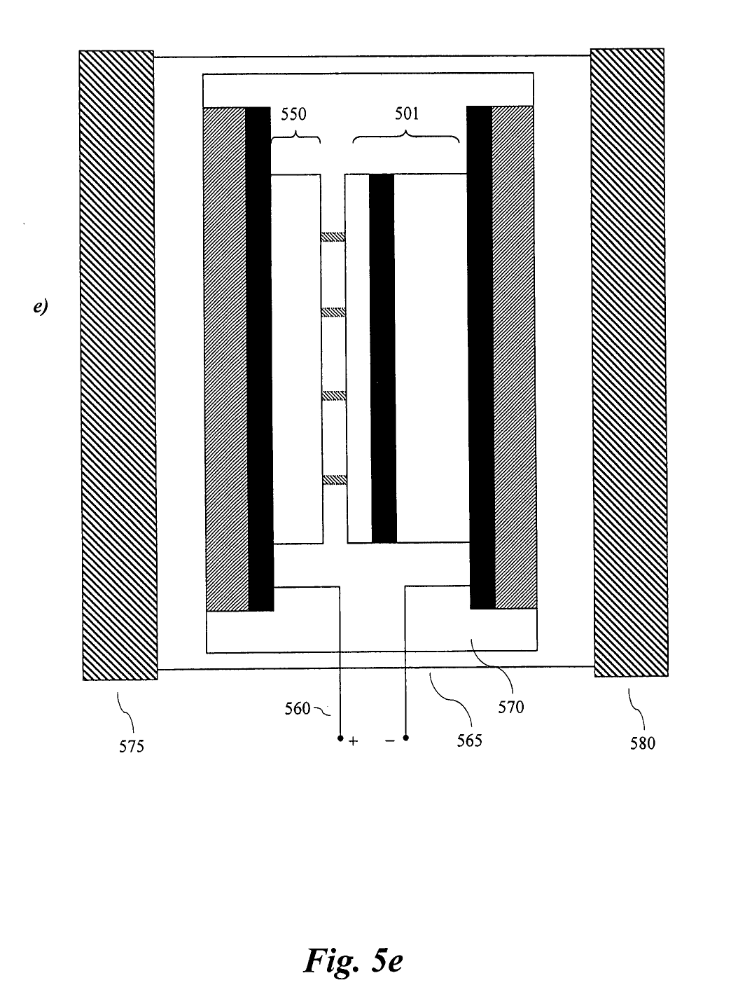

The RTH and cooling devices comprising such according to the invention can be manufactured with methods well known in the semiconductor industries, such as MBE or CVD for example. A suitable method will be briefly outlined with reference to FIG. 5a-e. A structure with AlGaN/AlN/AlGaN is used as a non limiting example—other semiconductrors/insulators can be provided in the same manner. A metal layer 510, such as Al, Cu, their alloys, etc., which is to act as the contact to the external electric circuit, is grown on top of a substrate 505. After that, the nanoscaled semiconductor heterostructure is grown, consisting of one layer of doped AlGaN 515 forming the base of the electrode, one layer of AlN 520, forming a potential barrier, and finally a layer of AlGaN 525 which forms a quantum well between the AlN layer 520 and the adjacent gap (shown in FIG. 5e). The layers 515-525 form the first electrode 501. If a superlattice is to be grown, the steps of growing AlN and AlGaN is repeated a pre-determined number of times.

The vacuum gap will be narrow, even if the RTH according to the invention makes it possible to use widths that are technologically achievable. However, also with widths around 50 Å there is a risk of contact between the electrodes due to bending. According to one embodiment of the invention this is addressed by placing insulating spacers in the vacuum gap. According to this embodiment a mask 530, provided with through holes 532 (outlined by the dotted boxes in the figure), is placed on top of the semiconductor structure. Such mask can be produced with conventional lithographic methods. AlN is then grown on top of the mask, and will fill the holes 532.

In FIG. 5b the mask has been removed leaving a number of AlN pillars 535, forming spacers which will effectively control the vacuum gap width. Alternatively, rather than using a lift-off method to form the spacers, the spacers may be formed by selective growth inside the mask openings and/or by deposition of a AlN layer followed by photolithographic patterning of a resist mask above the layer and etching of the layer. Additionally, the material on the sides of the device is etched away, down to the metal layer to be able to contact it properly. FIG. 5b illustrates the first electrode.

The second electrode 550 is constructed in the same manner, FIG. 5c-d, but without the heterostructure and pillars as shown in FIG. 5a-b. The doped AlGaN side of this electrode is then pressed against the pillar-side of the first electrode which is the final device, which is schematically illustrated in FIG. 5e. The contacts are attached to an external electric circuit 560, and the device is sealed by enclosure 565 providing a small vacuum chamber 570. The first 501 and second 550 electrodes are in connection to respective reservoirs, 575 and 580. In the illustrated embodiment, the first electrode 501 is the cooling part and reservoir 580 the cooling reservoir.

An alternative way of controlling the width of the vacuum gap is to include piezo actuators in the devices, which can be arranged to dynamically control the width of the gap.

While the invention has been described in connection with what is presently considered to be the most practical and preferred embodiments, it is to be understood that the invention is not to be limited to the disclosed embodiments, on the contrary, is intended to cover various modifications and equivalent arrangements within the appended claims.

1. A solid state cooling/power generating device comprising a first electrode and a second electrode separated by a vacuum gap, wherein:
at least one of the electrodes comprises a nanoscaled heterostructure, the nanoscaled heterostructure comprising at least one first thin film and at least one second thin film, and a material of the at least one first thin film has a higher bandgap than a material of the at least one second thin film; and
the vacuum gap is arranged adjacent to the at least one second thin film thereby forming a quantum well such that the vacuum gap in combination with the at least one first and the at least one second thin film forms at least a double barrier resonance structure providing conditions which allow resonant tunneling between the first and second electrode.

2. The solid state cooling/power generating device according to claim 1, wherein the nanoscaled heterostructure is arranged to provide resonant tunneling at a plurality of separate energy windows, wherein the energy window with the lowest energy is to its greater part above the characteristic energy of the electrodes.

3. The solid state cooling/power generating device according to claim 2, wherein nanoscaled spacers are provided in the vacuum gap, the width of the vacuum gap defined by the spacers.

4. The solid state cooling/power generating device according to claim 1, wherein the nanoscaled heterostructure is arranged to provide resonant tunneling at a plurality of separate energy windows, wherein the energy window with a lowest energy matches a characteristic energy of the electrodes.

5. The solid state cooling/power generating device according to claim 2, wherein the energy window with the lowest energy is within the characteristic energy±30% of k_{B}T.

6. The solid state cooling/power generating device according to claim 1, wherein the nanoscaled heterostructure comprises a plurality of first thin films alternating with a plurality of the second thin films in a superlattice arrangement, the superlattice ending with one second thin film adjacent to the vacuum gap, and wherein the material of the first thin films has a wider bandgap than the material of the second thin films.

7. The solid state cooling/power generating device according to claim 1, wherein the first thin film comprises a semiconductor with a first bandgap and the second thin film comprises a semiconductor with a second bandgap.

8. The solid state cooling/power generating device according to claim 1, wherein the first thin film comprises an insulator and the second thin film comprises a semiconductor.

9. The solid state cooling/power generating device according to claim 8, wherein the first thin film is made of AlN and the second thin film is made of AlGaN.

10. The solid state cooling/power generating device according to claim 7, wherein the first thin is made of AlGaAs and the second thin film is made of GaAs.

11. The solid state cooling/power generating device according to claim 7, wherein the first thin film is made of Si and the second thin film is made of SiGe.

12. The solid state cooling/power generating device according to claim 8, wherein nanoscaled spacers of an insulating material are provided in the vacuum gap, the width of the vacuum gap defined by the insulating spacers.

13. A method of making a solid state cooling/power generating device comprising a first electrode and a second electrode, with a vacuum gap of nanoscaled dimensions in between the first and the second electrodes, the method comprising the steps of:
providing a mask with through holes on the first electrode;
filling the through holes by growing an insulator on top of the mask, thereby providing insulating spacers on the first electrode;
removing the mask to uncover the insulating spacers; and
pressing the second electrode on top of the insulating spacers, the insulating spacers thereby defining the width of the gap formed in between the first and second electrode.

14. The method according to claim 13, further comprising, prior to the step of providing the mask:
growing a metal layer, which is to act as a contact to an external electric circuit, on top of a substrate; and
providing a nanoscaled heterostructure on top of the metal layer by growing one layer of a doped semiconductor, followed by at least one layer of a first material forming a potential barrier, and a layer of a second material, wherein the first material has a wider bandgap than the second material.

15. The method according to claim 14, further comprising steps of alternating growing a layer of the first material and a layer of the second material, repeated a predetermined number of times to form a superlattice.

16. A solid state cooling/power generating device comprising a first electrode and a second electrode separated by a vacuum gap, wherein at least one of the first and the second electrodes comprises a quantum well.

17. The solid state cooling/power generating device according to claim 16, wherein the quantum well is located in a semiconductor layer in the first electrode between the vacuum gap and a barrier layer.

18. The solid state cooling/power generating device according to claim 17, wherein the barrier layer comprises a semiconductor or an insulator.

19. The solid state cooling/power generating device according to claim 16, wherein the quantum well is located in a superlattice in the first electrode.

20. The solid state cooling/power generating device according to claim 16, wherein the device is sealed in a vacuum chamber.
